(19) United States
(12) Patent Application Publication
(10) Pub. No.: US 2019/0190106 A1
(43) Pub. Date: Jun. 20, 2019

(54) MILLIMETER WAVE WAVEGUIDE CONNECTOR WITH INTEGRATED WAVEGUIDE STRUCTURING

(71) Applicants: TELESPHOR KAMGAING, Chandler, AZ (US); SASHA OSTER, Chandler, AZ (US); Georgios Dogiamis, Chandler, AZ (US); Adel Elsherbini, Chandler, AZ (US); Shawna Liff, Scottsdale, AZ (US); Aleksandar Aleksov, Chandler, AZ (US); JOHANNA SWAN, Scottsdale, AZ (US); Brandon Rawlings, Chandler, AZ (US)

(72) Inventors: TELESPHOR KAMGAING, Chandler, AZ (US); SASHA OSTER, Chandler, AZ (US); Georgios Dogiamis, Chandler, AZ (US); Adel Elsherbini, Chandler, AZ (US); Shawna Liff, Scottsdale, AZ (US); Aleksandar Aleksov, Chandler, AZ (US); JOHANNA SWAN, Scottsdale, AZ (US); Brandon Rawlings, Chandler, AZ (US)

(21) Appl. No.: 16/328,524

(22) PCT Filed: Sep. 30, 2016
(86) PCT No.: PCT/US16/54900

§ 371 Date: Feb. 26, 2019

(51) Int. Cl. H01P 1/04; H01P 1/02; H01P 3/12; H01P 11/00

(52) U.S. Cl. CPC H01P 1/042; H01P 1/022; H01P 11/002; H01P 3/121; H01P 3/122

(57) ABSTRACT

Generally, this disclosure provides apparatus and systems for coupling waveguides to a server package with a modular connector system, as well as methods for fabricating such a connector system. Such a system may be formed with connecting waveguides that turn a desired amount, which in turn may allow a server package to send a signal through a waveguide bundle in any given direction without bending waveguides.

### TECHNICAL FIELD

The present disclosure relates to systems and methods for coupling waveguides to package substrates.

### BACKGROUND

As more devices become interconnected and users consume more data, the demand placed on servers accessed by users has grown commensurately and shows no signs of letting up in the near future. Among others, these demands include increased data transfer rates, switching architectures that require longer interconnects, and extremely cost and power competitive solutions.

There are many interconnects within server and high performance computing (HPC) architectures today. These interconnects include within blade interconnects, within rack interconnects, and rack-to-rack or rack-to-switch interconnects. In today's architectures, short interconnects (for example, within rack interconnects and some rack-to-rack) are achieved with electrical cables—such as Ethernet cables, co-axial cables, or twin-axial cables, depending on the required data rate. For longer distances, optical solutions are employed due to the very long reach and high bandwidth enabled by fiber optic solutions. However, as new architectures emerge, such as 100 Gigabit Ethernet, traditional electrical connections are becoming increasingly expensive and power hungry to support the required data rates and transmission range. For example, to extend the reach of a cable or the given bandwidth on a cable, higher quality cables may need to be used or advanced equalization, modulation, and/or data correction techniques employed which add power and latency to the system. For some distances and data rates required in proposed architectures, there is no viable electrical solution today. Optical transmission over fiber is capable of supporting the required data rates and distances, but at a severe power and cost penalty, especially for short to medium distances, such as a few meters.

Waveguides have not been used in modern server and HPC architectures in part because the compact nature of these architectures require some degree of flexibility in the chosen interconnect methods. With modern assembly and implementation methods, when waveguides are bent, some cross-sectional deformation is common. As waveguides largely rely on a consistent cross-section for signal integrity, even slight deformation often results in levels of signal degradation that are unacceptable for most server and HPC applications. Also, as signal frequencies increase, waveguides' dimensions decrease. As dimensions decrease, alignment tolerances become stricter. Thus, using current systems and methods, optical waveguides are difficult to reliably and appropriately connect to their source at the scales these applications demand. Further, as data rates increase, signal degradation tolerances tend to decrease, so today's electrical waveguides and their assembly methods are trending to become even less feasible for these applications in the future.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1A illustrates a view of an example waveguide connector in accordance with at least one embodiment described herein;

FIG. 1B illustrates a cross-section of the waveguide connector in FIG. 1A along sectional line B-B;

FIG. 2 illustrates a cross-section of the waveguide connector in FIG. 1A along sectional line B-B in accordance with another embodiment described herein;

FIG. 3 illustrates a cross-section of the waveguide connector in FIG. 1A along sectional line B-B in accordance with another embodiment described herein;

FIG. 4A illustrates a cross-section of an example waveguide connector in accordance with at least one embodiment described herein;

FIG. 4B illustrates a cross-section of the waveguide connector of FIG. 4A, including added peripheral members;

FIG. 4C illustrates a cross-section of the waveguide connector of FIGS. 4A-4B, including added sacrificial material;

FIG. 4D illustrates a cross-section of the waveguide connector of FIGS. 4A-4C, including added top members;

FIG. 4E illustrates a cross-section of the waveguide connector of FIGS. 4A-4D, including additional layers;

FIG. 4F illustrates a cross-section of the waveguide connector of FIGS. 4A-4E, including an added top layer;

FIG. 4G illustrates a cross-section of the waveguide connector of FIGS. 4A-4F, with sacrificial material partially or completely removed, leaving behind cavities;

FIG. 4H illustrates a cross-section of the waveguide connector of FIGS. 4A-4G, with additional material added;

FIG. 5 illustrates a cross-section of an example waveguide connector in accordance with at least one other embodiment described herein;

FIG. 6 is a high-level flow diagram of an illustrative method of fabricating a waveguide connector in accordance with one embodiment described herein;

FIG. 7 is a high-level flow diagram of an illustrative method of partially or completely filling a waveguide with a dielectric material in accordance with one embodiment described herein;

FIG. 8A illustrates a cross-section of an example waveguide connector in accordance with at least one embodiment described herein, including traces on a base layer;

FIG. 8B illustrates a cross-section of the waveguide connector of FIG. 8A, including and added layer;

FIG. 8C illustrates a cross-section of the waveguide connector of FIGS. 8A-8B, including additional traces;

FIG. 8D illustrates a cross-section of the waveguide connector of FIGS. 8A-8C, including an additional layer;

FIG. 8E illustrates a cross-section of the waveguide connector of FIGS. 8A-8D, including an additional layer;

FIG. 8F illustrates a cross-section of the waveguide connector of FIGS. 8A-8E, with traces partially or completely removed, leaving behind cavities;

FIG. 8G illustrates a cross-section of the waveguide connector of FIGS. 8A-8F, with additional material added;

FIG. 9 illustrates a cross-section of an example waveguide connector in accordance with another embodiment described herein;

FIG. 10 is a high-level flow diagram of an illustrative method of fabricating a waveguide connector in accordance with one embodiment described herein;

FIG. 11 is a high-level flow diagram of an illustrative method of partially or completely filling a waveguide with a dielectric material in accordance with one embodiment described herein;

FIG. 12 illustrates a three-dimensional cutaway view of an example waveguide connector in accordance with at least one embodiment described herein;

FIG. 13 illustrates a three-dimensional cutaway view of another example waveguide connector in accordance with at least one embodiment described herein;

FIG. 14 illustrates a general three-dimensional cutaway view of another example waveguide connector in accordance with at least one embodiment described herein;

FIG. 15 illustrates a general three-dimensional view of a waveguide connector system in accordance with at least one embodiment described herein;

Although the following Detailed Description will proceed with reference being made to illustrative embodiments, many alternatives, modifications and variations thereof will be apparent to those skilled in the art.

### DETAILED DESCRIPTION

Generally, this disclosure provides apparatus and systems for coupling waveguides to a server package with a modular connector system, as well as methods for fabricating such a connector system. Such a system may be formed with connecting waveguides that rotate through a desired angle, which in turn may allow a server package to send a signal through a waveguide bundle in any given direction without bending waveguides of the bundle.

A power-competitive data transmission means that can support very high data rates over short to medium distances would be extremely advantageous. The systems and methods disclosed herein provide waveguide connector systems and methods that may facilitate the transmission of data between blade servers (“blades”) within a server rack or between collocated server racks using millimeter-waves (mm-waves) and sub-Terahertz (sub-THz) waves. For example, mm-waves are electromagnetic waves having frequencies from about 30 GHz to about 300 GHz, and sub-THz waves are electromagnetic waves having frequencies ranging from about 100 GHz to about 900 GHz. The waveguide connector systems disclosed herein may enable the coupling of one or more waveguide members to a package in a location proximate to the radio frequency (“RF”) launchers or antennas carried by the package. The systems and methods disclosed herein may facilitate the coupling of one or more waveguides to the packages either individually or grouped together using a modular connector or similar device. Put simply, one embodiment of the system disclosed herein may effectively serve as a modular “joint” or adaptive connector between a package output and a waveguide bundle. This is advantageous because it allows waveguide bundle connections between packages without bending the bundle itself and without particularly realigning the packages. For example, using one of the systems disclosed herein at each end of a waveguide bundle may advantageously allow a straight-line waveguide bundle to connect two different packages whose input/output ports are not facing each other, without moving the packages.

The systems and methods disclosed herein may further facilitate the fabrication of modular waveguide connector systems. More particularly, the introduction of a printed fabrication method may allow nonlinear waveguides to be constructed or implemented without bending.

The terms “horizontal” and “vertical” as used in any embodiment herein are not used as terms of limitation, but merely as relative terms to simplify descriptions of components of those embodiments. The terms may be substituted or interchanged with no impact on the intended meaning or scope of the description of any embodiment. For example, a component described as vertical may be horizontal if the system to which the component is attached is rotated through an angle of 90°. The terms “row” and “column” are similarly used herein as relative terms for simplification purposes only, and may be substituted or interchanged with no impact on intended meaning or scope. The terms “first” and “second” are similarly used herein as relative terms for simplification purposes only, and may be substituted or interchanged with no impact on intended meaning or scope. The terms “height,” “width” and “depth” are similarly used herein as relative terms for simplification purposes only, and may be substituted or interchanged with no impact on intended meaning or scope. The term “package” is used herein to describe a package substrate. The package may be any kind of package substrate including organic, plastic, ceramic, or silicon used for a semiconductor integrated circuit.

Some Figures include an XYZ compass to denote a 3-dimensional coordinate system. This is included and used for clarity and explanatory purposes only; the embodiments depicted are not intended to be limited by the inclusion or use of such a coordinate system. The labels or directions may be substituted or interchanged with no impact on intended meaning or scope.

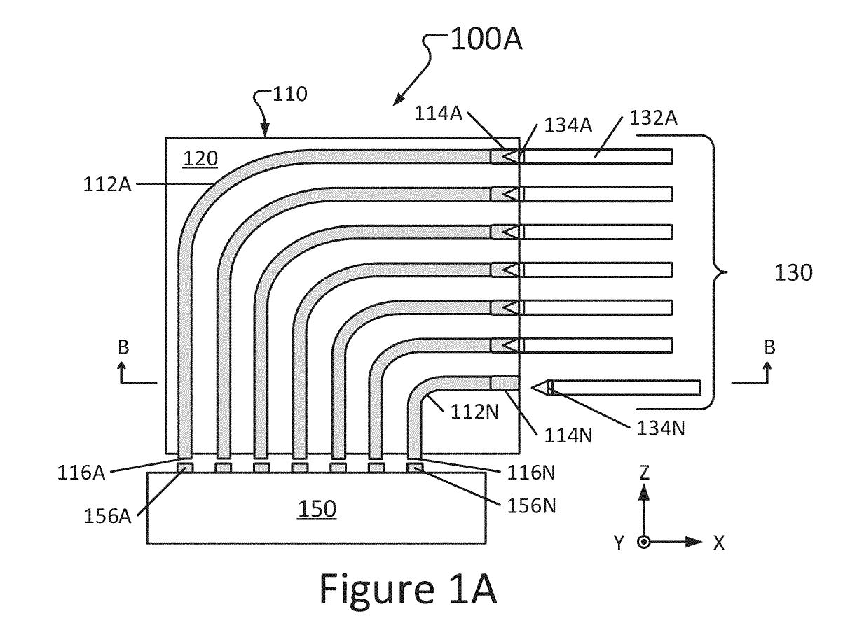

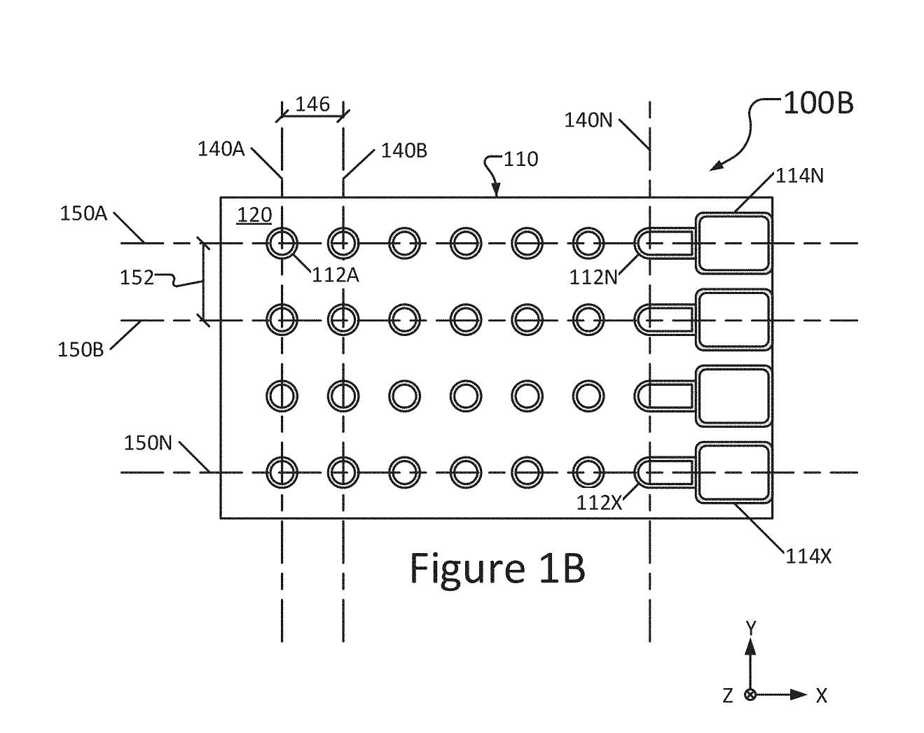

FIG. 1A illustrates a view 100A of an example waveguide connector 110 in accordance with at least one embodiment described herein. FIG. 1B illustrates a cross-section 100B of the waveguide connector 110 in FIG. 1A along sectional line B-B.

Turning to FIG. 1A, a first end of a waveguide connector 110 may be operably coupled to waveguide bundle 130 and/or a second end of the waveguide connector 110 may be operably coupled to a package, such as package 150. Package 150 may be any of a plurality of materials, such as organic materials (e.g., dielectric materials) sandwiched between metallic traces (e.g., copper). Waveguide connector 110 may include a housing 120 disposed about all or a portion of some or all of the one or more waveguides 112A-112N (collectively referred to as “waveguides 112”). Waveguide bundle 130 may contain one or more external waveguides 132A-123N (collectively referred to as “external waveguides 132”). Package 150 may contain one or more launchers or excitation elements such as outputs 156A-156N (collectively referred to as “package outputs 156”), capable of bidirectional or unidirectional communication with one or more external devices via a waveguide (such as one of external waveguides 132). Package outputs 156 may also serve as package inputs at the same time, or at different times.

Waveguide connector 110 may be any of a plurality of dimensions. For example, waveguide connector 110 may have a height of about 1 centimeter (cm) or greater, a width of about 1 cm or greater and a depth of about 1 cm or greater. However, any or all of these dimensions may vary; waveguide connector 110 may have a height of about 1.5 cm or greater, a width of about 0.5 cm or greater and a depth of about 20 cm or greater. These dimensions allow the waveguide connector 110 to advantageously fit between blades in a server rack, thereby not requiring reconfiguration or repositioning of blades within the rack.

Housing 120 may be made of a plurality of materials, such as metal, plastic, a composite, etc. Housing 120 may be of a conductive or nonconductive material. Housing 120 may be attached, affixed, secured, or otherwise operably coupled to waveguide bundle 130 and/or package 150. Housing 120 may partially or completely enclose each of waveguides 112.

Each of waveguides 112 may be of any physical configuration, cross-section or geometry, such as straight, bent or curved. Each of waveguides 112 may be partially or fully contained within housing 120. Each of waveguides 112 may have a first end and a second end, connected by walls. The walls of waveguides 112 may be made of any of a plurality of conductive materials, such as metals, polymers, composites, etc. In another embodiment, housing 120 may be made of a material suitable for providing all or a portion of one or more walls of some or all of the waveguides 112, allowing waveguides 112 to be fabricated without creating individual walls (in such an embodiment, the walls of each of waveguides 112 would instead simply be provided in whole or in part by the housing 120 itself). Each of waveguides 112 may be hollow, partially filled with a dielectric material, or fully filled with a dielectric material such as plastic, porcelain, glass, gaseous nitrogen, etc. In another embodiment, waveguides 112 may be left partially or completely hollow, using air or a vacuum as a dielectric. The dimensions of waveguides 112 may be any of a plurality of geometric configurations. For example, waveguides 112 may have a transverse cross-sectional geometry that is about 1 mm×2 mm or greater, about 3 mm×3 mm or greater, about 2 mm×0.5 mm or greater, etc. The cross-sectional dimensions of the waveguide may also vary with the frequency of operation and the dielectric properties of the waveguide filling. For example, a waveguide using air as a dielectric filling operating at a frequency of about 100 GigaHertz (GHz) may have a transverse cross-sectional geometry that is about 1 mm×about 2 mm, while a waveguide using air as a dielectric filling operating at a frequency of about 200 GHz may have a transverse cross-sectional geometry that is about 0.62 mm×about 1.2 mm. The length of waveguides 112 may be, for example, about 5 mm or greater, about 10 mm or greater, about 15 mm or greater, about 25 mm or greater, about 100 mm or greater, etc. Waveguides 112 may all be of a similar length, or may have different lengths. “Similar” lengths, as used herein may include waveguides whose lengths differ by, for example, about 0.1 mm or less, about 2 mm or less, about 5 mm or less, about 10 mm or less, or by about 1% or less, by about 3% or less, by about 5% or less, etc. Waveguides 112 may have a transverse cross-sectional geometry that is constant along their length, or may have a variable cross-sectional geometry. Some or all of waveguides 112 may have a transverse cross-sectional geometry different from other waveguides 112, or they may all have the same or similar transverse cross-sectional geometry. The possible cross-sectional geometries of waveguides 112 will be described in further detail below.

Waveguides 112 may be operably coupled to external waveguides 132. This may be accomplished in any of a number of ways. For example, one end of a waveguide 112 may terminate with a waveguide transition feature 114. One end of an external waveguide 132 may terminate in an external waveguide transition feature 134. These transition features may be changes in the cross-sectional dimensions of either the waveguide 112 or the external waveguide 132, and may be permanently attachable or detachably attachable to one another, allowing a waveguide 112 to attach, be secured, or otherwise operably couple to a corresponding external waveguide 132.

In another embodiment, one of the waveguide transition feature 114 or the external waveguide transition feature 134 may be absent. If the waveguide transition feature 114 is absent, then the external waveguide transition feature 134 is capable of operably coupling to waveguide 112 itself. Similarly, if the external waveguide transition feature 134 is absent, then the waveguide transition feature 114 is capable of operably coupling to the corresponding external waveguide 132 itself. In such an embodiment, waveguide transition feature may operably couple to the corresponding external waveguide 132 using, for example, mechanical friction. In additional embodiments, transition features 114 and/or 134 may be capable of attaching to either a waveguide or another transition feature. The form of the transition features 114 and 134 may vary and will be described in further detail below.

Similarly, waveguides 112 may be operably coupleable to package outputs 156 of package 150. One end of a waveguide 112 may terminate in a package output attachment feature 116. In some embodiments, package output attachment feature 116 is implemented as a transition feature, similar to waveguide transition feature 114. Package output 156 may attach directly to waveguide 112 without any package output attachment feature 116, as will be described in further detail below. Package output attachment feature(s) 116 may be fabricated into package 150 during the manufacturing process of package 150, or may be attached afterwards.

In some embodiments, waveguides 112 may remain on the same plane, as depicted in FIG. 1A. Each end of a waveguide (e.g., 112A) may be on the same plane as the corresponding end of the remaining waveguides (e.g., 112B-112X). In other embodiments, some or all of waveguides 112 may bend or curve in additional directions, which may result in some or all of waveguides 112 being on different planes or even failing to be on any single plane. As a simple clarifying example, for any defined XYZ Cartesian coordinate system, if a waveguide 112 is fabricated such that a first segment of the waveguide 112 is parallel to the Y axis, a second segment bends waveguide 112 90° to be parallel to the X axis, then after a straight third segment, a fourth segment bends waveguide 112 another 90° to be parallel to the Z axis, then waveguide 112 will not fall within any single two-dimensional plane in the defined space XYZ.

A waveguide 112 may be attached to both an external waveguide 132 and a package output 156. This attachment may allow the signal from package output 156 to travel through, propagate through, or otherwise excite waveguide 112 and external waveguide 132. Package output 156 may serve as an input, meaning this attachment may allow a signal from external waveguide 132 to travel through, propagate through, or otherwise excite waveguide 112 and into the package input. Advantageously, the use of a waveguide may reduce or even eliminate signal degradation.

Waveguide connector 110 may be detachably attachable or permanently attachable to waveguide bundle 130, as will be described in further detail below. Waveguide connector 110 may also be detachably attachable or permanently attachable to package 150, as will be described in further detail below.

FIG. 1B illustrates a cross-section 100B of the waveguide connector 110 in FIG. 1A along sectional line B-B. Waveguides 112 may be arranged along columns 140A-140N (hereinafter referred to as “columns 140”) or horizontal rows 150A-150N (hereinafter referred to as “rows 150”). As seen in FIG. 1B, waveguide connector 110 may contain a plurality of vertically stacked rows of waveguides 112. For example, waveguide 112N, depicted in both FIG. 1A and FIG. 1B, may be above waveguide 112X, depicted in FIG. 1B. Waveguides 112 in a column 140 are horizontally offset from waveguides in a different column 140 by a horizontal offset 146. Horizontal offset 146 may be, for example, about 10 μm or greater, about 50 μm or greater, about 0.5 mm or greater, about 1 mm or greater, about 1.5 mm or greater, about 2 mm or greater, about 5 mm or greater, about 10 mm or greater, etc. Waveguides 112 in a row 150 are vertically offset from waveguides 112 of a different row by a vertical offset 152. Vertical offset 152 may be, for example, about 10 μm or greater, about 50 μm or greater, about 0.5 mm or greater, about 1 mm or greater, about 1.5 mm or greater, about 2 mm or greater, about 5 mm or greater, about 10 mm or greater, etc. In some embodiments, waveguides 112 may actually contact other waveguides 112 (e.g., horizontal offset 146 and/or vertical offset 152 may be zero). Waveguide connector 110 may only have a single row of waveguides 112A-112N. In another embodiment, waveguide connector 110 may only contain a single column of waveguides 112N-112X. While FIG. 1B depicts waveguides 112 arranged in a grid, rows 150 may be also horizontally offset from other rows 150, as will be described in further detail below.

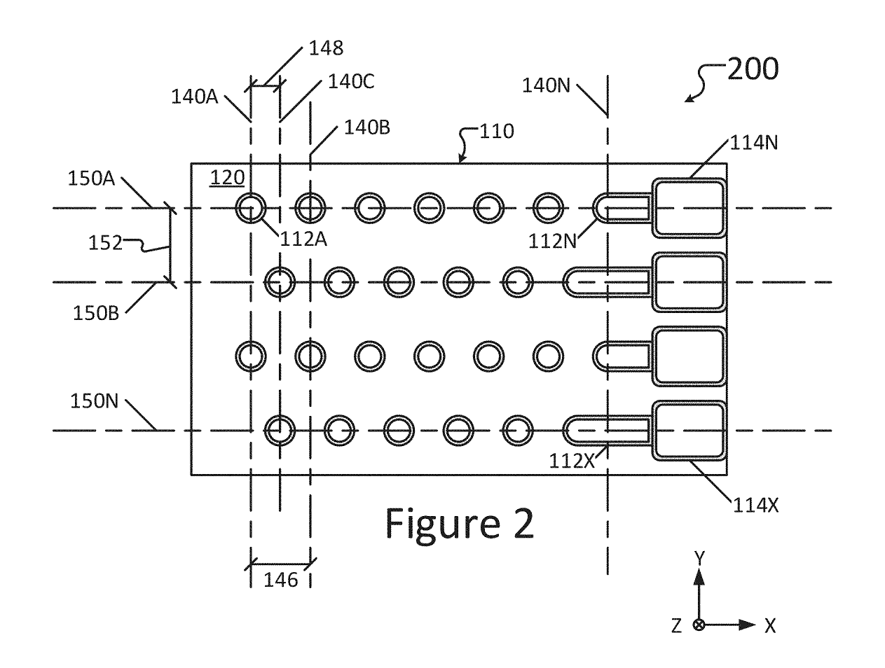

FIG. 2 illustrates a cross-section 200 of the waveguide connector 110 in FIG. 1A along sectional line B-B in accordance with another embodiment described herein. In this embodiment some or all rows 150 of waveguides 112 may be staggered or offset from other rows 150. For example, waveguides 112 of row 150B are not horizontally aligned with any waveguides 112 of row 150A. The leftmost waveguides 112 of rows 150B and 150N are instead aligned in column 140C, which is offset from column 140A by staggered offset 148. Staggered offset 148 may be, for example, about 0.25 mm or greater, about 0.5 mm or greater, about 1 mm or greater, about 1.5 mm or greater, about 2 mm or greater, about 5 mm or greater, about 10 mm or greater, etc. As depicted in FIG. 2, column 140C may also be offset from column 140B. Column 140C may be offset from column 140B by the same staggered offset 148 (placing column 140C directly between columns 140A and 140B), or column 140C may be offset from column 140B by a different amount. Some rows 150 of waveguides 112 may align with other rows 150. Each of waveguides 112 may be connected to a waveguide transition feature 114 or to a package output attachment feature 116 (not shown in FIG. 2).

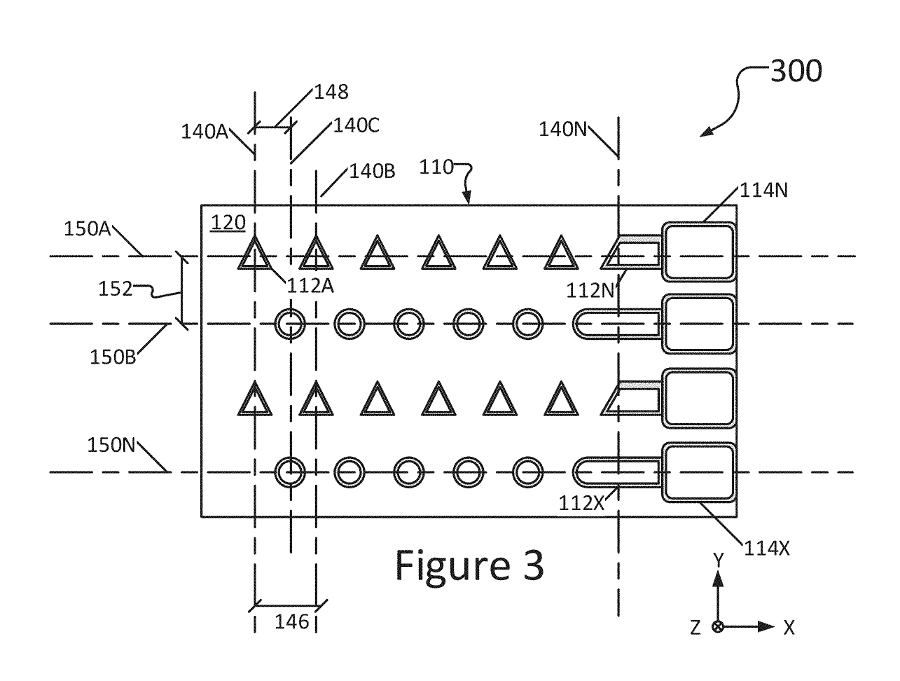

FIG. 3 illustrates a cross-section 300 of the waveguide connector 110 in FIG. 1A along sectional line B-B in accordance with another embodiment described herein. As shown in FIG. 3, some of waveguides 112 may have different cross-sectional geometries than other waveguides 112. For example, waveguide 112A is depicted in FIG. 3 with a triangular cross-sectional geometry, while waveguide 112X has a circular cross-sectional geometry. Waveguides 112 may also have different cross-sectional geometries from other waveguides 112 contained within the same row 150. The cross-sectional geometry of each waveguide 112 may be any polygonal shape. Dimensional notations of rows 150, columns 140, and offsets 152, 146, and 148 have been retained in FIG. 3 for simplicity.

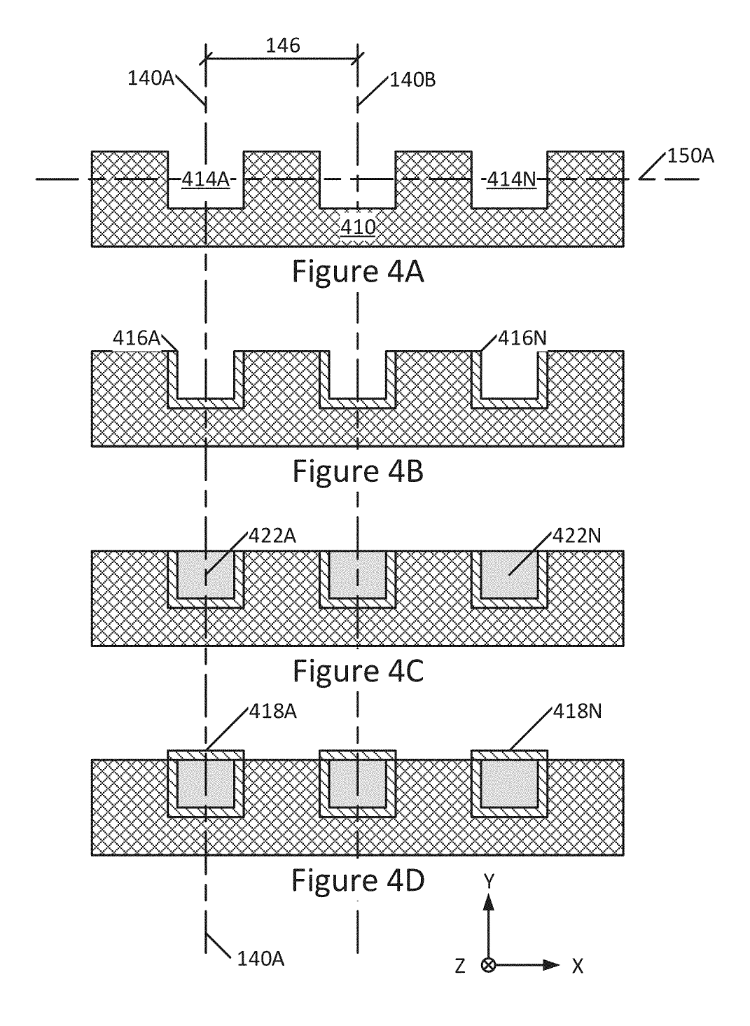

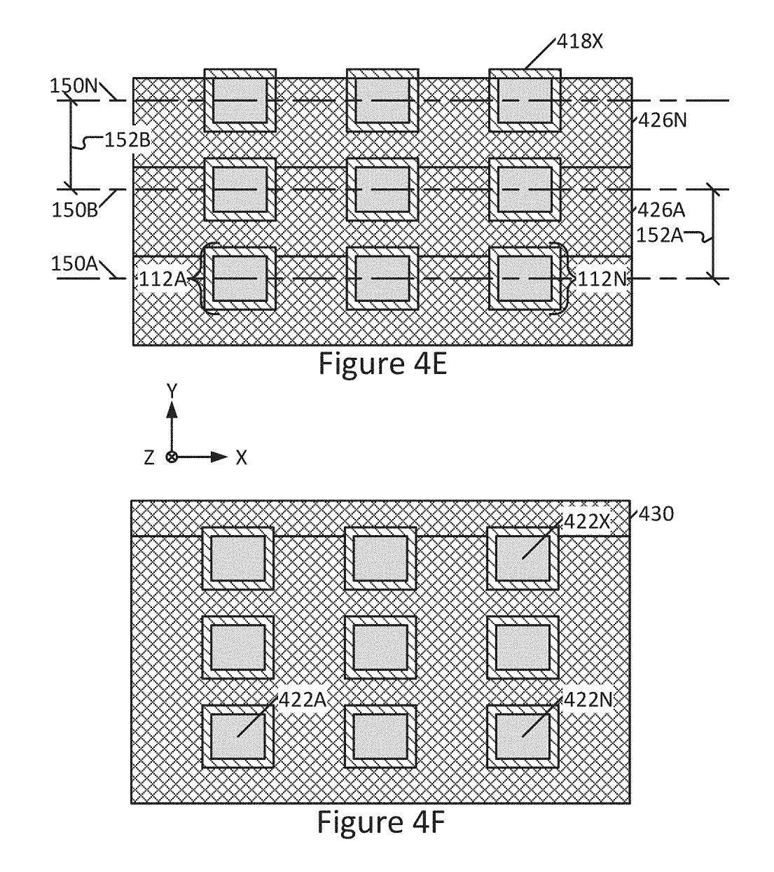

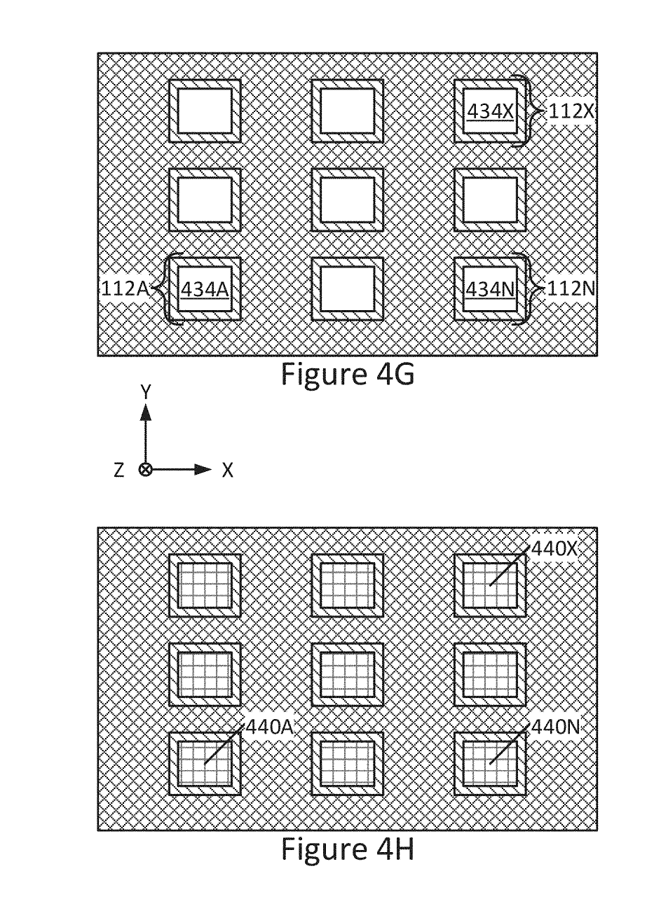

FIGS. 4A-4H illustrate cross-sections of an illustrative example of a waveguide connector 110 in accordance with at least one embodiment described herein. FIG. 4A illustrates a base layer 410. Base layer 410 may be made of a non-conductive substrate such as a ceramic, a polymer, a plastic, or a dielectric composite material. Dielectric composite materials suitable for base layer 410 include glass-reinforced or paper-reinforced epoxy resins using dielectrics such as polytetrafluoroethylene, FR-4, FR-1, CEM-1, CEM-3, phenolic paper, or various other materials known to those skilled in the art. Base layer 410 may have any physical configuration or geometry. For example, base layer 410 may be about 30 mm or greater×about 4 mm or greater×about 30 mm or greater, or about 20 mm or greater×about 3 mm or greater×about 100 mm or greater, etc. Base layer 410 may be formed using any of a variety of methods. For example, base layer 410 may be formed using printing, 3D-printing, plating, photolithographic deposition, etc. Base layer 410 may have one or more grooves 414A-414N (collectively referred to as “grooves 414”). Grooves 414 may be evenly spaced from each other, or may be spaced inconsistently. Grooves 414 may be any of a plurality of sizes. For example, grooves 414 may be the same or larger than waveguides 112. Grooves 414 may be straight, curved, or bent. Grooves 414 may be any polygonal shape. Grooves 414 may be formed simply by fabricating base layer 410 “around” them (i.e., neglecting to fill in grooves 414), or may be formed subtractively (i.e., by removing material from base layer 410 to leave grooves 414).

FIG. 4B illustrates a cross-section of the waveguide connector of FIG. 4A, including added peripheral members 416A-416N (collectively referred to as “peripheral members 416”). Peripheral members 416 may be added to the inside of grooves 414. Peripheral members 416 may be made of any one of a variety of conductive materials, including metals (copper, silver, gold, etc.) semiconductors, etc. Peripheral members 416 may be fabricated by any one of a variety of methods, including plating, depositing, thermal oxidation, lamination, photolithographic deposition, electroplating, electroless plating, 3D printing, etc. Peripheral members 416 may have any thickness. For example, peripheral members 416 may be about 1 μm or greater, about 20 μm or greater, about 50 μm or greater, about 100 μm or greater, about 150 μm or greater, about 250 μm or greater, etc.

FIG. 4C illustrates a cross-section of the waveguide connector of FIGS. 4A-4B, including added sacrificial material 422A-422N (collectively referred to as “sacrificial material 422”). Metallized grooves 414A may be partially or completely filled with sacrificial material 422. The sacrificial material 422 may be a dielectric material, metal, plastic, composite, etc. In some embodiments, the sacrificial material 422 is a placeholder material and may be partially or completely removed later, as will be described below. In other embodiments, sacrificial material 422 is not removed, and may function as a component of one or more of waveguides 112.

FIG. 4D illustrates a cross-section of the waveguide connector of FIGS. 4A-4C, including added top members 418A-418N (collectively referred to as “top members 418”). Top members 418 may be added on top of sacrificial material 422 and peripheral members 416. Top members 418 may be made of any one of a variety of conductive materials, including metals (copper, silver, gold, etc.) semiconductors, etc. Top members 418 may be fabricated by any one of a variety of methods, including plating, depositing, thermal oxidation, lamination, photolithographic deposition, electroplating, electroless plating, 3D printing, etc. Top members 418 may combine with peripheral members 416 to partially or fully enclose sacrificial material 422. As top members 418 are added, they may combine with peripheral members 416 to form the walls of waveguides 112. Top members 418 may be similar in size or thickness to peripheral members 416 (e.g., within +/−10 μm).

FIG. 4E illustrates a cross-section of the waveguide connector of FIGS. 4A-4D, including additional layers 426A-426N (collectively referred to as “additional layers 426”). Additional layers 426 may be added to base layer 410. Each of additional layers 426 may be formed in a manner similar to that depicted in FIGS. 4A-4D. Additional layers 426 may partially or completely enclose the top members 418 of preceding layers. In another embodiment, no additional layers 426 are added.

FIG. 4F illustrates a cross-section of the waveguide connector of FIGS. 4A-4E, including an added top layer 430. Top layer 430 may be added to the uppermost (or topmost) layer of the waveguide connector. The topmost layer may be the last additional layer 426 added, or if no additional layers 426 have been added base layer 410 is also the topmost layer. Top layer 430 may partially or completely enclose top members 418 and/or waveguides 112 of the topmost layer.

FIG. 4G illustrates a cross-section of the waveguide connector of FIGS. 4A-4F, with sacrificial material 422 partially or completely removed, leaving behind cavities 434A-434X (collectively referred to as “cavities 434”). The exact method of removal may depend on the specific makeup of sacrificial material 422. For example, if sacrificial material 422 is made of a metal, removal may be accomplished chemically, mechanically, electrochemically, thermally, or combinations thereof. However, for example, if sacrificial material 422 is a plastic, removal may preferentially be accomplished chemically, but may also be accomplished mechanically, electrochemically, thermally, or combinations thereof. Various other methods of removal may be feasible, as known by those skilled in the art.

In some embodiments, waveguides 112 may be left partially or completely hollow, and fabrication of waveguides 112 may be considered complete at the point depicted in FIG. 4G. In other embodiments, waveguides 112 may be filled with a material, as will be described in further detail below. In other embodiments, sacrificial material 422 may be a dielectric material with an acceptable dielectric constant and loss tangent and is not removed. “Acceptable” dielectric constants may include, for example, dielectric constants of about 10 or less. The range of acceptable loss tangents may depend on the waveguide. For “internal” waveguides such as waveguides 112, acceptable loss tangents include, for example, loss tangents about 0.1 or less. External waveguides 132 may generally have stricter tolerances for loss tangents, e.g. may require a loss tangent of about 0.02 or less.

FIG. 4H illustrates a cross-section of the waveguide connector of FIGS. 4A-4G, with additional material 440. Additional material 440 may be a dielectric such as a ceramic, a polymer, a plastic, or a dielectric composite material. The filling may be performed via depositing, plating, printing, etc.

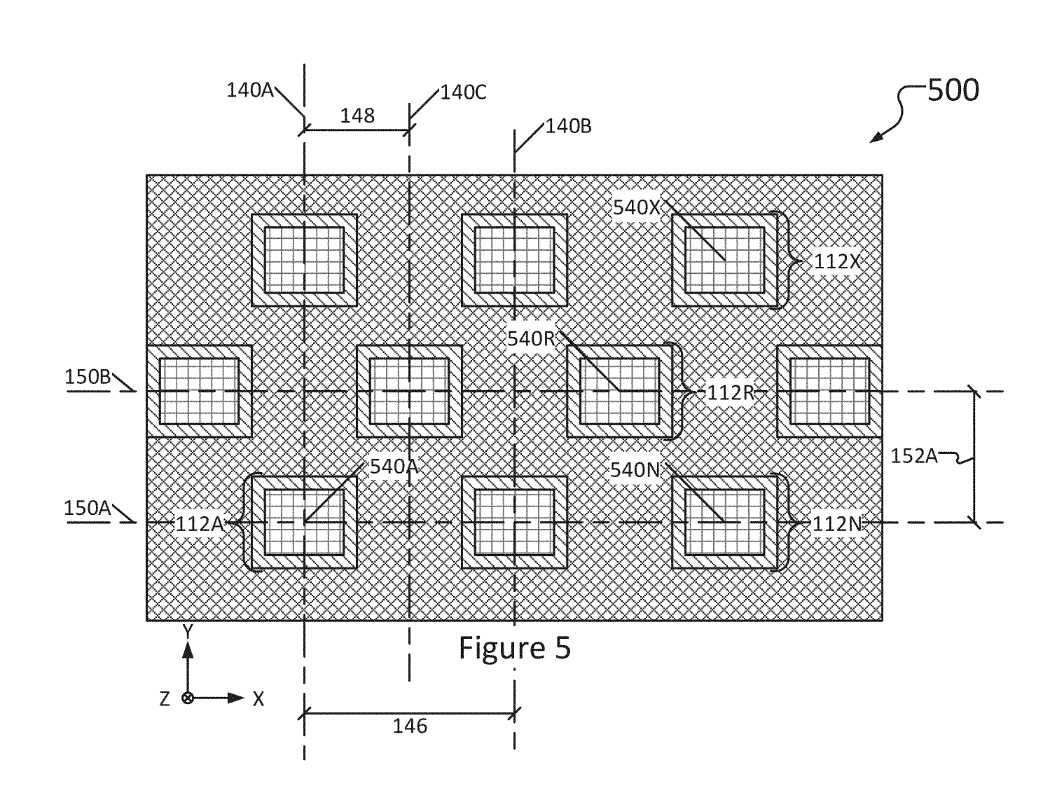

FIG. 5 illustrates a cross-section 500 of an example waveguide connector in accordance with at least one other embodiment described herein. Instead of adding additional layers 426 directly on top of each other or base layer 112, additional layers 426 may be added in a “staggered” configuration, as seen in FIG. 5. Thus, rows 150 of waveguides 112 may be offset from one another. For example, waveguide 112R may be offset from waveguides 112N and 112X. In some embodiments, no waveguides may be vertically or horizontally aligned with any others. In other embodiments, some waveguides may be vertically aligned with others, as in a column 140. As depicted in FIG. 5, waveguides 112 may be filled with additional material 440, as described above. In some embodiments, waveguides 112 may be left partially or completely hollow.

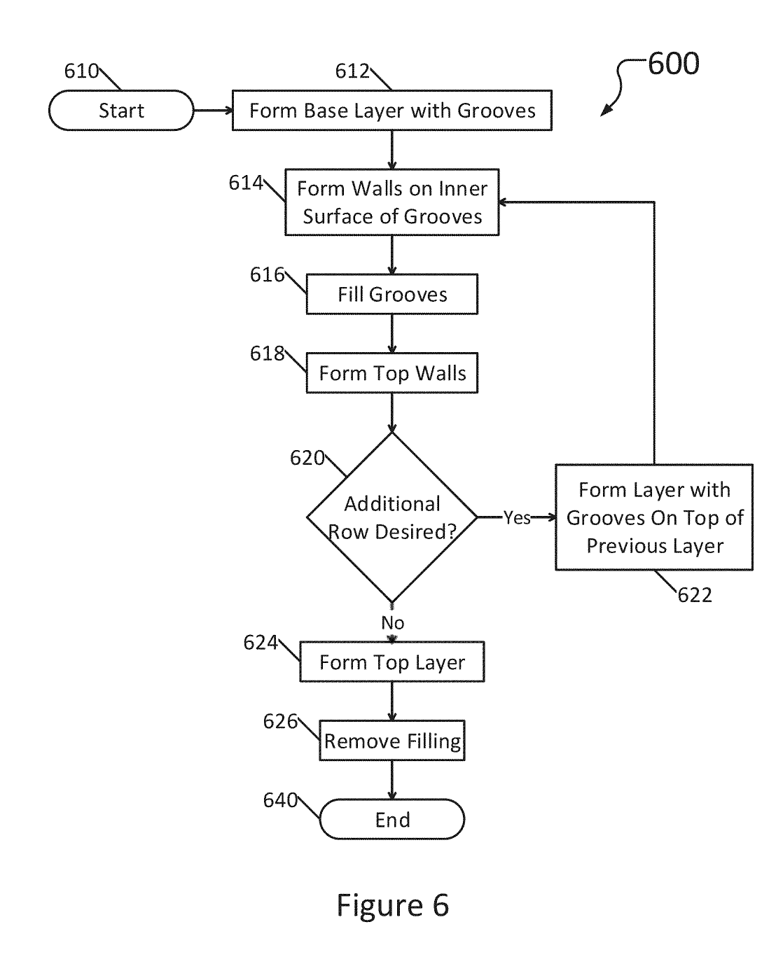

FIG. 6 is a high-level flow diagram of an illustrative method 600 of fabricating a waveguide connector in accordance with one embodiment described herein. Generally, method 600 involves forming a base layer with grooves, preparing those grooves to function as waveguides, and optionally adding additional similar layers of waveguides. Method 600 may generally result in the various stages of fabrication of a waveguide connector depicted in FIGS. 4A-4H.

At 610, a process of manufacturing a waveguide connector is initiated. At 612, a base layer (such as base layer 410) is formed. Base layer 410 may be fabricated through a variety of means, including subtractive processes, additive processes, semi-additive processes, 3D printing, plating, etc. In this embodiment, 612 further entails forming base layer 410 with a plurality of grooves (such as grooves 414). Grooves 414 may be formed simply by fabricating base layer 410 “around” them (i.e., neglecting to fill in grooves 414), or may be formed subtractively (i.e., by removing material from base layer 410 to leave grooves 414).

At 614, walls (such as peripheral members 416) are formed on the inner surfaces of grooves 414. As described above, peripheral members 416 may be fabricated by any one of a variety of methods, including plating, depositing, thermal oxidation, lamination, photolithographic deposition, electroplating, electroless plating, etc.

At 616, grooves 414 are filled. Grooves 414 may be filled with a sacrificial dielectric material (such as sacrificial material 422). The filling may be performed via depositing, plating, printing, etc.

At 618, top walls (such as top members 418) are added on top of sacrificial material 422. Sacrificial material 422 may be partially or completely enclosed at this point by peripheral members 416 and top members 418. Top members 418 may be formed in the same or a similar manner as peripheral members 416, or may be formed using a different one of the possible methods of forming peripheral members 416. For example, even if peripheral members 416 are formed using photolithographic deposition, top members 418 may be formed using 3D-printing.

At 620, a determination is made of whether one or more additional rows (such as rows 150) of waveguides (such as waveguides 112) are desired. If any additional rows 150 are desired, then method 600 may further include repeating 614-620 to form an additional layer (such as additional layers 426), resulting in an additional row 150 of waveguides 112. Note that the row 150 of waveguides 112 of an additional layer 426 may be offset from the previous row, as depicted in FIG. 5. If at 620 no additional rows 150 are desired, then at 624, a top layer (such as top layer 430) may be formed above the uppermost layer (which may be base layer 410 or one of additional layers 426).

At 626, the filling is removed. This filling may be sacrificial material 422. As discussed above, sacrificial material 422 may be accomplished, for example, chemically, mechanically, electrochemically, thermally, or using combinations thereof. At 640, the process is ended.

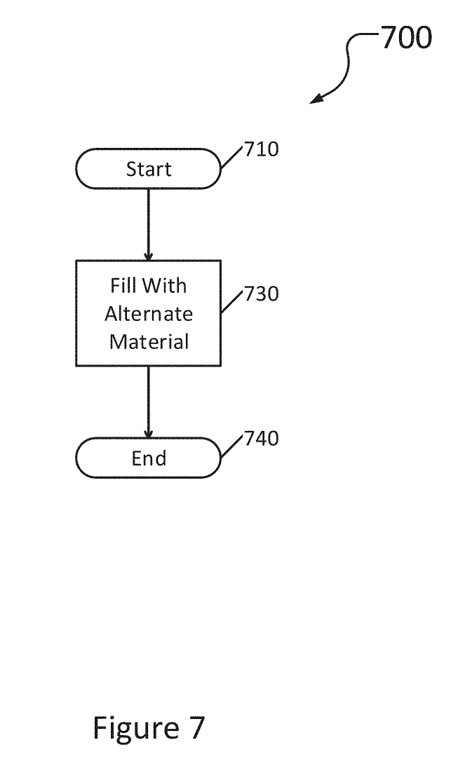

FIG. 7 is a high-level flow diagram of an illustrative method 700 of partially or completely filling a waveguide (such as one of waveguides 112) with a dielectric material (such as additional material 440). At 710, a process of filling a waveguide is initiated. At 730, cavities (such as cavities 434) are filled with another material, such as additional material 440. This filling may be performed via depositing, plating, printing, etc. At 740, the process is ended.

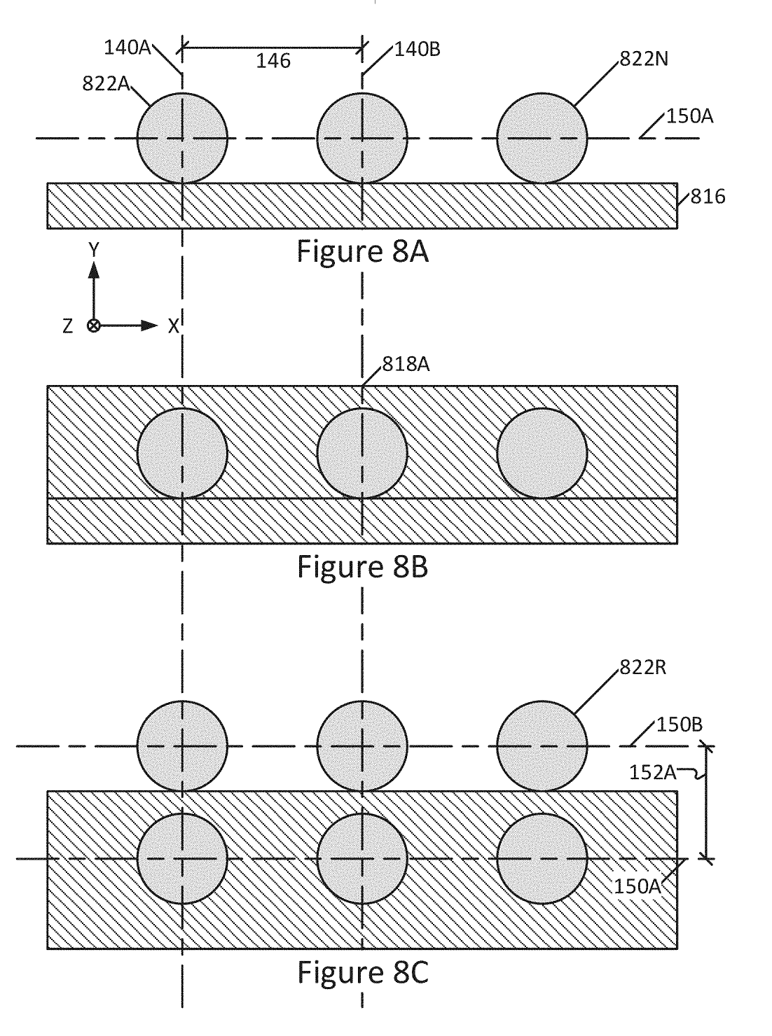

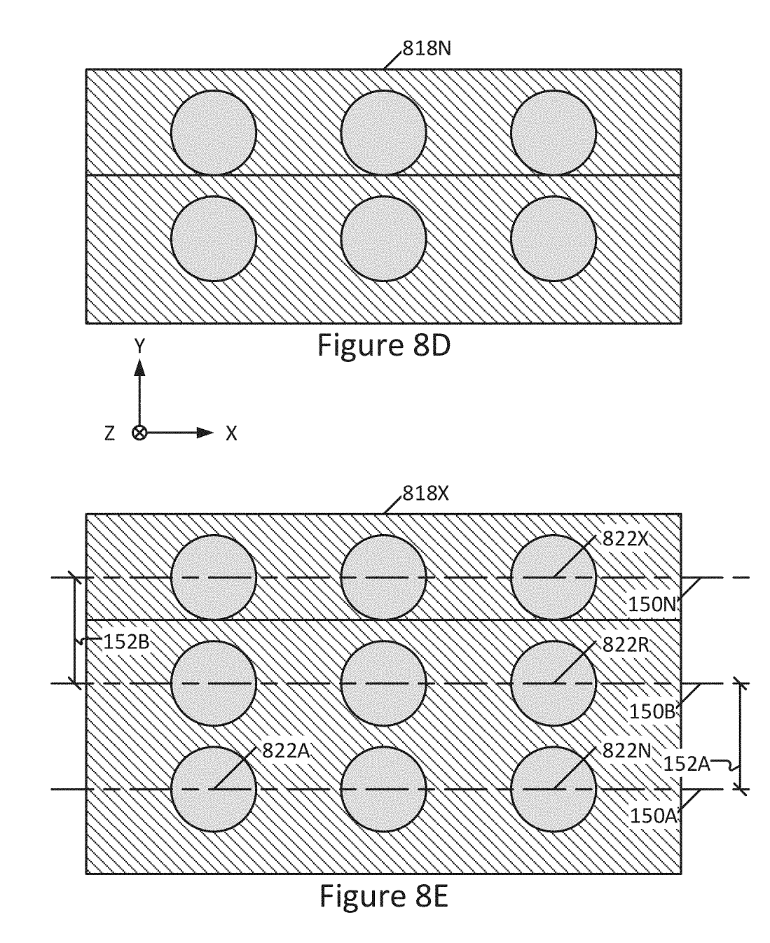

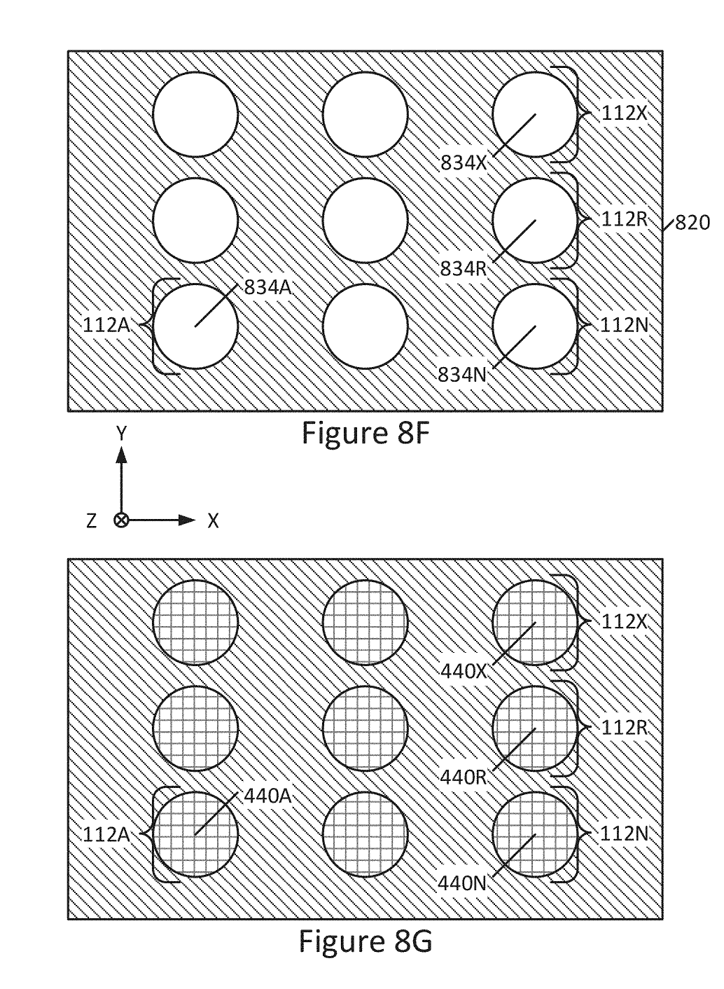

FIGS. 8A-8G illustrate cross-sections of an example waveguide connector in accordance with at least one embodiment described herein. FIG. 8A illustrates a cross-section of an example waveguide connector in accordance with at least one embodiment described herein, including traces 822A-822N (collectively referred to as “traces 822”) on a base layer 816. Base layer 816 may be made of a metal, or any other conductive material. Base layer 816 may be fabricated via plating, depositing, 3D printing, etc. Base layer 816 may have any physical configuration or geometry. For example, base layer 816 may be about 30 mm or greater×about 4 mm or greater×about 30 mm or greater, or about 20 mm or greater×about 3 mm or greater×about 100 mm or greater, etc. Traces 822 may be sacrificial members made of a sacrificial material, including the possible materials of sacrificial material 422 (including a dielectric, a metal, a dielectric-coated metal, a plastic, a composite material, etc.), and may be removed later, as will be described in detail below. Traces 822 may be straight, curved, or bent. Traces 822 may be added to base layer 816 in any of a variety of ways, including printing, 3D-printing, depositing, attaching, plating, etc. Traces 822 may have a cross-sectional geometry (as seen in FIG. 8A) of any polygonal shape. Traces 822 may be of any size in any dimension, such as about 0.5 mm or greater×about 1 mm or greater, about 1 mm or greater×about 1 mm or greater, about 2 mm or greater×about 0.5 mm or greater, etc.

FIG. 8B illustrates a cross-section of the waveguide connector of FIG. 8A, including and added layer 818A. Layer 818A may be added on top of base layer 816, and may partially or completely enclose traces 822A-N.

FIG. 8C illustrates a cross-section of the waveguide connector of FIGS. 8A-8B, including additional traces (including trace 822R). These additional traces may be added on top of layer 818A. The traces of the row including trace 822R may be aligned with the traces below them, such as along columns 140, or they may be offset or staggered, as will be discussed in further detail below. The traces 822 added on top of layer 818A may be added using substantially the same method(s) described above. Traces 822 may be aligned along rows, such as rows 150, and may be horizontally offset from each other by horizontal offset 146. If traces 822 are staggered, they may be horizontally offset from traces 822 of a different row 150 by a different offset value, such as staggered offset 148, as will be described in further detail below.

FIG. 8D illustrates a cross-section of the waveguide connector of FIGS. 8A-8C, including an additional layer 818N. Layer 818N may partially or completely enclose trace 822R and other traces 822 on the same row 150. Layer 818N may be made of the same materials and may be formed in the same way as Layer 818A.

FIG. 8E illustrates a cross-section of the waveguide connector of FIGS. 8A-8D, including an additional layer 818X. Layer 818X which may be added using the operations depicted in FIG. 8C-8D. In another embodiment, no layers beyond 818A are be added. In another embodiment, traces 822 are made of a dielectric material suitable for waveguides 112, and are therefore not removed.

FIG. 8F illustrates a cross-section of the waveguide connector of FIGS. 8A-8E, with traces 822 partially or completely removed, leaving behind cavities 834A-834X (collectively referred to as “cavities 834”). The exact method of removal may depend on the specific makeup of traces 822. For example, if traces 822 are made of a metal, removal may be accomplished chemically, mechanically, electrochemically, thermally, or using combinations thereof. As a different example, if traces 822 are a plastic, removal may be accomplished preferably chemically, but may still be accomplished mechanically, electrochemically, thermally, or using combinations thereof. Various other methods of removal may be feasible, as known by those skilled in the art. In some embodiments, waveguides 112 may be left partially or completely hollow, as in FIG. 8F. In other embodiments, waveguides 112 may be filled with another material 440. In still other embodiments, traces 822 may be a dielectric material and are not removed.

FIG. 8G illustrates a cross-section of the waveguide connector of FIGS. 8A-8F, with additional material 440 added. As described above, additional material 440 may be partially or completely filled into waveguides 112 via a plurality of methods. For example, waveguides 112 may be partially or completely filled with additional material 440 via depositing, plating, printing, etc.

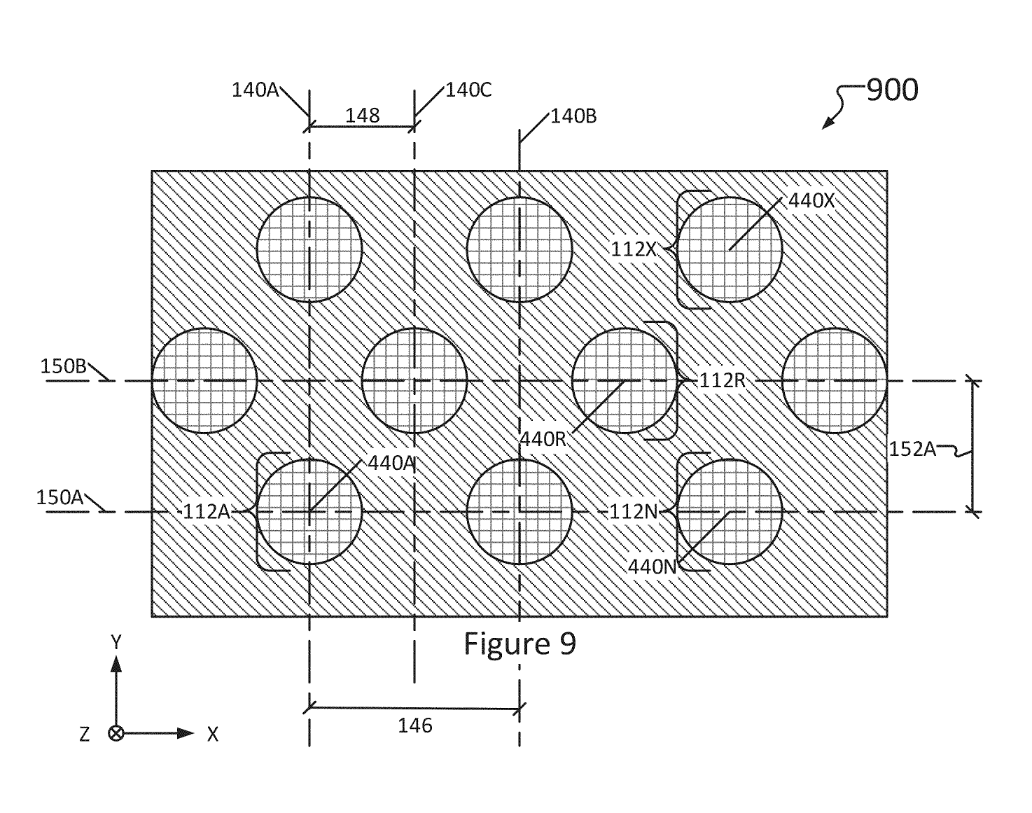

FIG. 9 illustrates a cross-section 900 of an example waveguide connector in accordance with another embodiment described herein. Instead of adding additional layers 818N-818X so that waveguides 112 are directly on top of each other or the waveguides 112 of layer 818A as in FIG. 8, additional layers 818N-818X may be added in a “staggered” configuration, as seen in FIG. 9. Thus, rows 150 of waveguides 112 may be added such that columns 140 of waveguides 112 are horizontally offset from one another. For example, waveguide 112R may be offset from waveguides 112N and 112X. In some embodiments, no waveguides may be vertically or horizontally aligned with any others. In other embodiments, some waveguides may be vertically aligned with others. As depicted in FIG. 9, waveguides 112 may be partially or completely filled with additional material 440, as discussed above. Waveguides 112 may be left partially or completely hollow.

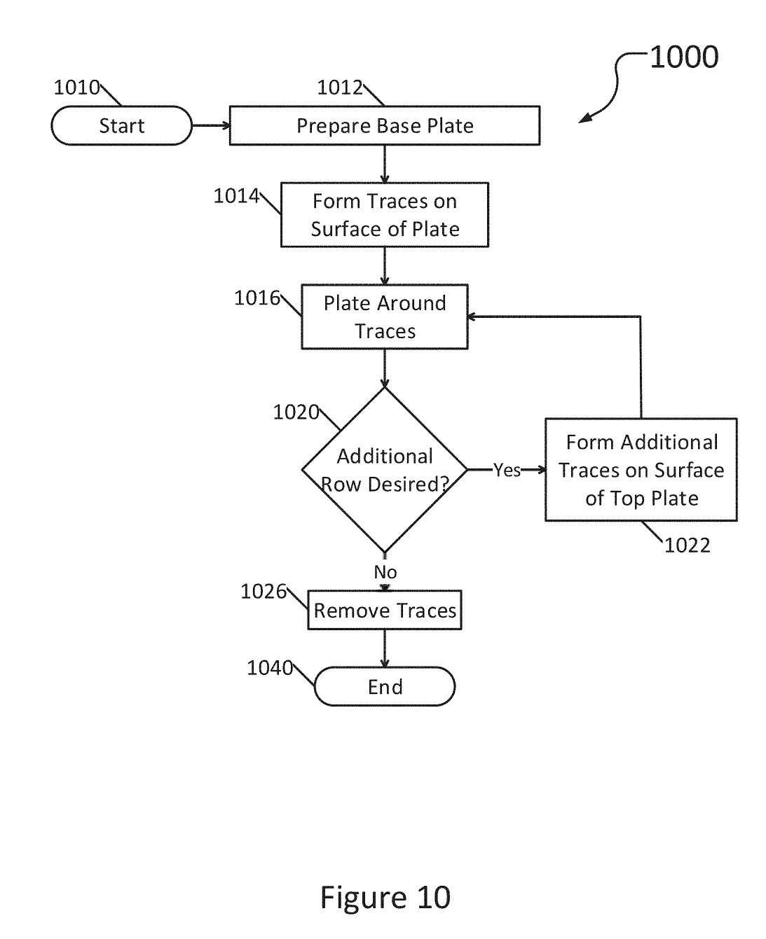

FIG. 10 is a high-level flow diagram of an illustrative method 1000 of fabricating a waveguide connector in accordance with one embodiment described herein. Generally, method 1000 involves preparing a base plate with formed traces, adding any desired additional layers of plate and traces, and removing the traces. Method 1000 may generally result in the various stages of fabrication of a waveguide connector depicted in FIGS. 8A-8G.

At 1010, a process of manufacturing a waveguide connector is initiated. At 1012, a base plate (such as base layer 816) is formed. Base layer 816 may be fabricated through a variety of means, including subtractive processes, additive processes, semi-additive processes, 3D printing, plating, etc.

At 1014, traces (such as traces 822) are formed on the surface of the plate. As discussed above, traces 822 may be added to base layer 816 in any of a variety of ways, including printing, 3D-printing, depositing, attaching, plating, etc. At 1016, additional plating (such as layer 818A) is formed around traces 822. Additional layer 818A may be added in any of the ways base layer 816 is made, including subtractive processes, additive processes, semi-additive processes, 3D printing, plating, etc.

At 1020, a determination is made of whether or not to add additional rows (such as rows 150 of waveguides 112). If additional rows 150 are desired, further operations may include forming additional traces 822 on the surface of the uppermost plate (such as layer 818A, or the most recently added additional layer 818) and proceeding from 1016. If no additional rows 150 are desired at 1020, at 1026 traces 822 are removed. At 1040, the process is ended.

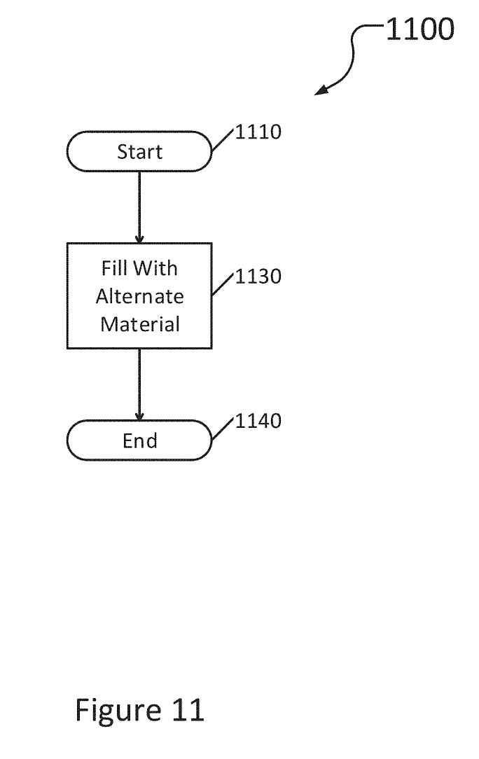

FIG. 11 is a high-level flow diagram of an illustrative method 1100 of partially or completely filling a waveguide (such as one of waveguides 112) with a dielectric material (such as additional material 440). At 1110, a process of filling a waveguide is initiated. At 1130, cavities (such as cavities 834) are filled with another material, such as additional material 440. This filling may be performed via depositing, plating, printing, etc. At 1140, the process is ended.

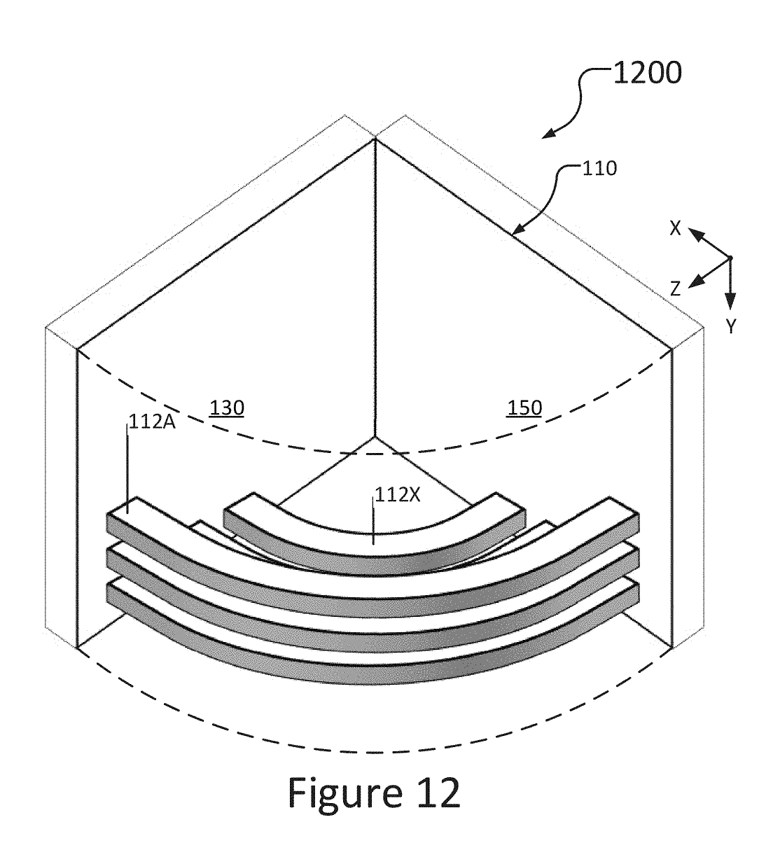

FIG. 12 illustrates a three-dimensional cutaway view 1200 of an example waveguide connector 110 in accordance with at least one embodiment described herein. Waveguides 112A-112X may be operably coupled to waveguide bundle 130 and/or may be operably coupled to package 150. Note that none of the waveguides 112 depicted in FIG. 12 move in the positive or negative Y direction. This means that in this embodiment, multiple waveguides 112 on the same X-Z plane may not have the same or similar length.

FIG. 12 depicts five waveguides 112 for ease of understanding. Other embodiments may have more or fewer waveguides 112. Further, as mentioned above, waveguides 112 may be partially or fully contained within housing 120, which has been cut away in FIG. 12 for simplicity. The boundaries of housing 120 are represented in FIG. 8 by dashed lines. While housing 120 is depicted as a “pie shape” in FIG. 12, housing 110 may be any of a plurality of shapes, including a cube, a partial sphere, or any other polygonal shape. Waveguides 112 may be curved, allowing a signal to propagate from package 150 to waveguide bundle 130 (or from waveguide bundle 130 to package 150) without bending either package 150 or waveguide bundle 130. Waveguides 112 may be partially or completely hollow or partially or completely filled with a material. Waveguides 112 may have waveguide transition features 114, which are not shown for simplicity. The dimensions of package 150 may vary. For example, package 150 may be about 20 mm or greater×about 20 mm or greater×about 0.5 mm or greater. The dimensions of waveguide bundle 130 may also vary. For example, waveguide bundle 130 may be about 2 meters (m) or greater×about 10 mm or greater×about 10 mm or greater. A 10 mm×10 mm waveguide connector 110 may contain, for example, 16 waveguides in a 4×4 array.

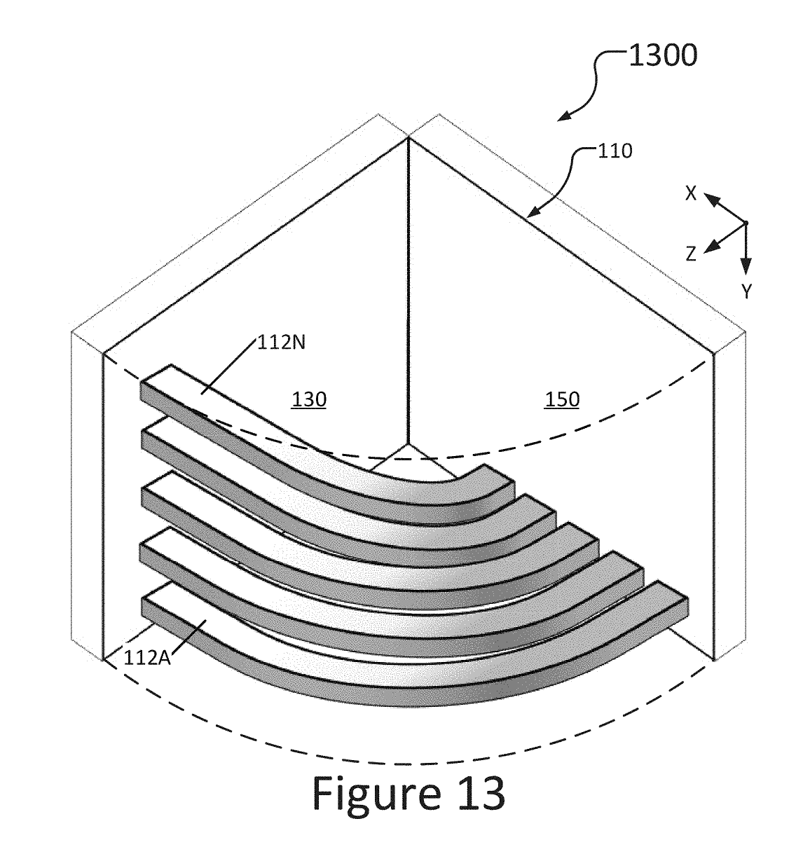

FIG. 13 illustrates a three-dimensional cutaway view 1300 of another example waveguide connector 110 in accordance with at least one embodiment described herein. Waveguides 112A-112N may be bent in more than one dimension. Waveguides 112 may be of equal length.

For example, waveguide 112A remains on the X-Z plane, but extends from the farthest corner (i.e., in the negative X direction) of package 150 to the farthest corner (i.e., in the positive Z direction) of waveguide bundle 130. However, in this embodiment, waveguide 112N extends from the closest corner (i.e., in the positive X direction) of the package. In some embodiments, such as that depicted in FIG. 12, all of waveguides 112 connect to a point on the same X-Z plane as they originate, and therefore waveguide 112N would have to connect to the closest corner (i.e., in the negative Z direction) of waveguide bundle 130 (for example, see waveguide 112X as depicted in FIG. 12). However, such a waveguide would be substantially shorter than, for example, waveguide 112A (as depicted in either FIG. 12 or FIG. 13). As signals carried or transported through waveguides may degrade depending on the length of a waveguide, it is advantageous to have all waveguides remain the same or similar length.

Thus, in the embodiment depicted in FIG. 13, waveguide 112N extends from the closest corner of the package 150 to the farthest corner (i.e., in the positive Z direction AND the negative Y direction) of the waveguide bundle 130. Extending in the Y direction as well advantageously allows waveguide 112N to have a length that is the same or similar to waveguide 112A (e.g., within ±50 μm).

As depicted in FIG. 13, waveguides 112 may each have one end in a horizontal alignment, but bend such that the other end of each of waveguides 112 is in a vertical alignment. This may allow waveguides 112 to propagate a signal between waveguide bundle 130 and package 150 without bending waveguide bundle 130 or package 150, and while advantageously keeping waveguides 112 at a constant or similar length. Keeping waveguides 112 at a constant or similar length is desirable because it may promote signal cohesion and alleviate dispersion. Because the length of a waveguide may impact the transmitted signal (e.g. impact their phase component), a waveguide connector such as one consistent with the present disclosure may be more effective or desirable if it keeps all of the waveguides at a constant or similar length. In other embodiments, waveguides 112 may be in other “transplanar” arrangements allowing waveguides 112 to be of a constant or similar length while bending.

Note that like FIG. 12, FIG. 13 also depicts five waveguides 112 for ease of understanding. Other embodiments may have more or fewer waveguides 112. Further, waveguides 112 may be partially or fully contained within housing 120, which has been cut away in FIG. 13 for clarity. The boundaries of housing 120 are represented in FIG. 13 by dashed lines.

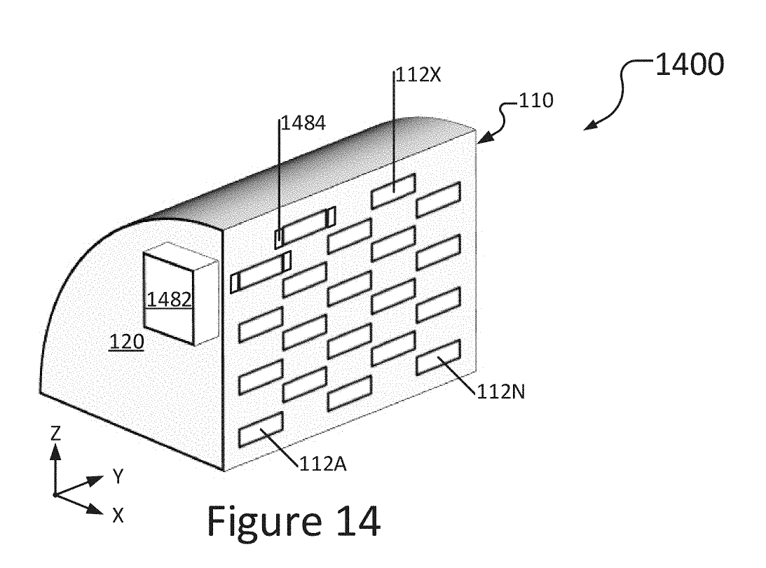

FIG. 14 illustrates a general three-dimensional cutaway view 1400 of another example waveguide connector 110 in accordance with at least one embodiment described herein. In this embodiment, connector 110 comprises housing 120 and waveguides 112A-112X. Only the first end of waveguides 112 is depicted in FIG. 14; the second end of waveguides 112 may be along the bottom face (where the bottom face is parallel to the X-Y plane at minimum Z) of housing 110. Note that in FIG. 14, waveguides 112 are depicted in a staggered layout, which is mentioned above as one possible embodiment. Waveguides 112 may be in a grid layout, or any other feasible layout (e.g., arranged along a single line, in a circle, in a plurality of concentric circles, in a “cross” or X layout, etc.). Waveguides 112 are also depicted as having a rectangular cross-sectional geometry, but as discussed above (e.g., FIG. 3), waveguides 112 may have any of a plurality of cross-sectional geometries. As discussed above (e.g., FIG. 12), housing 120 is depicted as having a “pie-slice” shape, but may have any of a plurality of shapes. A waveguide connector 110 may have one or more housing attachment features 1482, as depicted in FIG. 14. Housing attachment features 1482 may allow the waveguide connector 110 to attach, secure, or otherwise operable couple to either a waveguide bundle 130 (not shown) or a package 150 (not shown). Housing attachment features 1482 may be any of a variety of forms and utilize any of a variety of means to secure waveguide connector 110 to waveguide bundle 130 or package 150. For example, housing attachment features 1482 may utilize mechanical features (e.g., screws, bolts, ratchets, binding, snaps, etc.), chemical features (e.g., adhesives, bonding agents, etc.) thermal features (e.g., soldering, welding, etc.), or electromagnetic features (e.g., magnets, electrical fields, etc.). FIG. 14 also depicts waveguide attachment features 1484 alongside some of waveguides 112. Note that not all waveguides 112 are depicted in FIG. 14 as having waveguide attachment features 1484 for simplicity. In other embodiments, none, some, or all of waveguides 112 may have waveguide attachment features 1484. Waveguide attachment features 1484 allow waveguides 112 to be secured, attached, connected, or otherwise operably coupled to external waveguides 132 (not shown) or package outputs 156 (not shown). Waveguide attachment features 1484 may utilize any of the means described for housing attachment features 1482, such as mechanical features, chemical features, thermal features, or electromagnetic features. Waveguide attachment features 1484 are depicted in FIG. 14 as being external to housing 120. However, in other embodiments, waveguide attachment features 1484 may be partially or fully contained within housing 120.

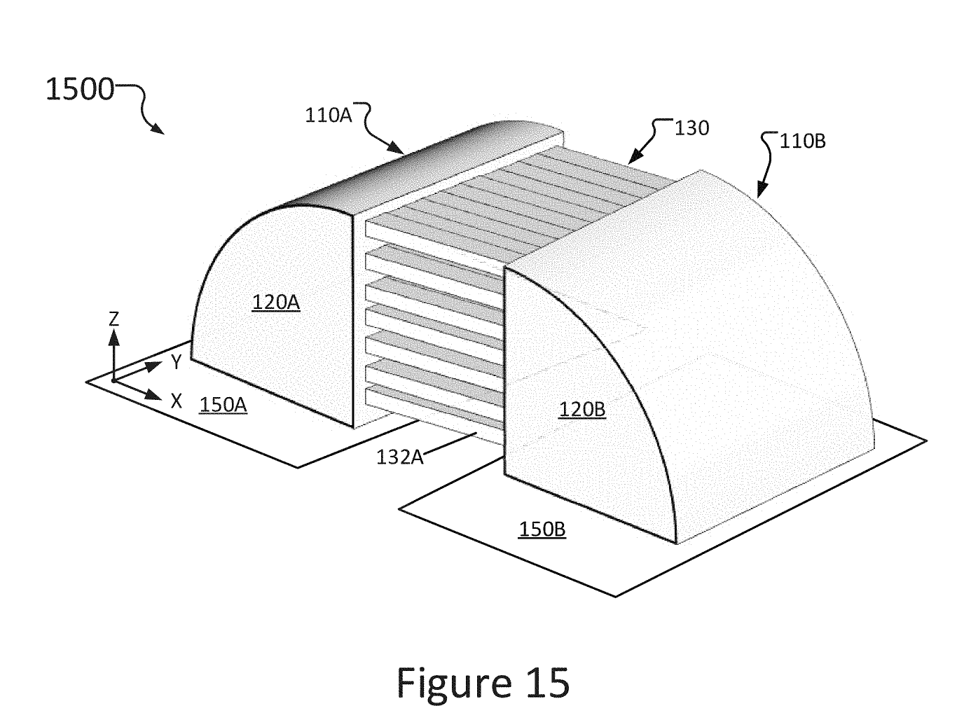

FIG. 15 illustrates a general three-dimensional view 1500 of a waveguide connector system in accordance with at least one embodiment described herein. Here, two connectors 110A and 110B may be operably coupled to packages 150A and 150B, respectively. Connectors 110A and 110B may also be operably coupled to waveguide bundle 130. Waveguide bundle 130 may use a variety of external waveguides such as 132A to operably connect connector 110A to connector 110B. This connection may allow a signal generated in package 150A to travel, propagate, or be transmitted through waveguides 112 (not shown) of connector 110A, into and through external waveguides 132, into and through waveguides 112 (not shown) of connector 110B into package 150B. Advantageously, such a signal propagation may be performed without bending package 150A, waveguide bundle 130 or package 150B.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1-25. (canceled)

26. A waveguide connector to operably couple one or more package excitation elements to at least one external waveguide, comprising:
a plurality of waveguides at least partially contained within a housing, each waveguide having a first end operably coupleable to a respective one of at least one package excitation elements, and a second end operably coupleable to a respective one of said at least one external waveguides, said ends being connected by walls, wherein:
said first end of each waveguide aligns with a first plane, and said second end of each waveguide aligns with a second plane disposed at an angle measured with respect to the first plane.

27. The waveguide connector of claim 26, wherein:
the plurality of waveguides is arranged in a two-dimensional waveguide array comprising a plurality of vertically stacked one-dimensional waveguide arrays at least partially contained within the housing; and
wherein each of the plurality of vertically stacked one-dimensional arrays is offset horizontally from the waveguides of an adjacent one-dimensional array.

28. The waveguide connector of claim 27, wherein the walls of the plurality of waveguides are conductive and the walls comprise at least one of: metal walls, composite walls, or plastic walls.

29. The waveguide connector of claim 26, wherein the waveguides are to operate at a millimeter-wave or sub-Terahertz frequency.

30. The waveguide connector of claim 26, wherein the housing comprises at least one of: a metal housing; a plastic housing; or a composite material housing.

31. The waveguide connector of claim 26, further comprising:
housing connection features enabling the waveguide connector to operably couple to at least one of a package or the at least one external waveguide; and
waveguide connection features enabling the at least one waveguide to operably couple to at least one of the one or more package excitation elements or the at least one external waveguide.

32. The waveguide connector of claim 31, wherein the housing connection features or the waveguide connection features comprise at least one of:
mechanical connection features;
chemical connection features;
thermal connection features; or
electromagnetic connection features

33. A method of fabricating a waveguide connector, said method comprising:
forming a plurality of waveguides arranged in a first row within a housing, said forming comprising:
forming a base housing layer, said base housing layer having a plurality of grooves formed therein, each of the plurality of grooves including at least:
a first end coincident with a first plane;
a second end coincident with a second plane, the second plane disposed at an angle measured with respect to the first plane; and
a curved surface coupling the first end with the second end;
depositing a conductive material on at least a portion of the curved surfaces forming the plurality of grooves;
at least partially filling each of the plurality of grooves with a sacrificial material;
depositing a conductive layer at least partially over the surface of the sacrificial material of each respective one of the plurality of grooves, each of the conductive layers conductively coupled to the conductive material deposited on the portion of the surfaces forming the respective grooves; and
forming a top housing layer across at least the conductive layers.

34. The method of claim 33, wherein forming a top housing layer across at least the conductive layers comprises:
forming one or more additional rows of waveguides, said forming of each additional row including:
forming an additional housing layer across at least the most recently deposited conductive layers, the additional housing layer having an additional plurality of grooves formed therein, each of the additional plurality of grooves including at least:
a first end coincident with a first plane;
a second end coincident with a second plane, the second plane disposed at an angle measured with respect to the first plane; and
a curved surface coupling the first end with the second end;
depositing a conductive material on at least a portion of the surfaces forming each of the additional plurality of grooves;
at least partially filling each of the additional plurality of grooves with a sacrificial material; and
depositing an additional conductive layer at least partially over the sacrificial material of each respective one of the additional plurality of grooves, each of the additional conductive layers conductively coupled to the conductive material deposited on the portion of the surface forming the respective additional grooves; and
forming a top housing layer across at least the most recently deposited conductive layers.

35. The method of claim 33, further comprising removing at least a portion of the sacrificial material.

36. The method of claim 35, further comprising at least partially filling at least one of the plurality of waveguides with a dielectric material.

37. The method of claim 33, wherein forming a base housing layer comprises forming a base housing layer using three-dimensional (3D) printing.

38. The method of claim 33, wherein depositing a conductive material and depositing a second conductive layer comprise photolithographic patterning.

39. A method of fabricating a waveguide connector, said method comprising:
forming at least one waveguide within a housing, said forming comprising:
depositing a conductive base layer;
depositing at least one sacrificial member comprising a sacrificial material, the at least one sacrificial member including at least:
a first end coincident with a first plane;
a second end coincident with a second plane, the second plane disposed at an angle measured with respect to the first plane; and
a peripheral surface on the conductive base layer, the peripheral surface being curved and coupling the first end with the second end; and
depositing a second conductive layer about at least a portion of the peripheral surface of the at least one sacrificial member.

40. The method of claim 39, further comprising removing at least a portion of the sacrificial material and at least partially filling at least one of the at least one waveguides with a dielectric material.

41. The method of claim 40 further comprising at least partially filling at least one of the at least one waveguides with a dielectric material.

42. The method of claim 39, wherein said depositing is performed using three-dimensional (3D) printing or direct metal laminating.

43. The method of claim 39, wherein the forming at least one waveguide comprises forming a plurality of waveguides arranged in a first row; and
wherein the depositing at least one sacrificial member comprising a sacrificial material comprises:
depositing a plurality of sacrificial members comprising a sacrificial material, each of the plurality of sacrificial members including at least:
a first end coincident with a first plane;
a second end coincident with a second plane, the second plane disposed at an angle measured with respect to the first plane; and
a peripheral surface on the conductive base layer, the peripheral surface being curved and coupling the first end with the second end.

44. The method of claim 43, further comprising:
forming one or more additional rows of waveguides, said forming of each additional row including:
depositing a plurality of sacrificial members on top of the topmost conductive layer; and
forming a conductive layer about at least a portion of the peripheral surfaces of the plurality of sacrificial members of the current row.

45. A waveguide transmission system comprising:
a package comprising a substrate and a plurality of excitation elements; and
a waveguide connector operably coupleable to said substrate and operably coupleable to a waveguide bundle, said waveguide connector comprising a housing and a plurality of waveguides at least partially contained within said housing, wherein each of the plurality of waveguides comprises:
a first end operably coupleable to one of said package antennae;
a second end operably coupleable to one of a plurality of external waveguides; and
walls connecting said first end to said second end.

46. The waveguide transmission system of claim 45, wherein the package comprises an organic material package and a plurality of conductive traces.

47. The waveguide transmission system of claim 45, wherein at least one of the plurality of waveguides is at least partially hollow.

48. The waveguide transmission system of claim 45, wherein the housing comprises at least one of: a metal housing; a plastic housing; or a composite material housing.

49. The waveguide transmission system of claim 45, wherein the waveguides are all of a similar length.

50. The waveguide transmission system of claim 45, wherein the waveguides are to operate at the mm-wave or sub-THz frequencies.
